(19) United States
(12) Patent Application Publication
(10) Pub. No.: US 2007/0123444 A1
(43) Pub. Date: May 31, 2007

(54) Fabric care article

(75) Inventors: Errol Hoffman Wahl, Cincinnati, OH (US); Jodi Lee Brown, Cincinnati, OH (US); Eugene Steven Sadlowski, Cincinnati, OH (US); Jose Andres Rojo Moreno, Loveland, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/601,240

(22) Filed: Nov. 17, 2006

Related U.S. Application Data
(60) Provisional application No. 60/738,274, filed on Nov. 18, 2005.

(51) Int. Cl. C11D 17/00

(52) U.S. Cl. 510/295; 510/439

(57) ABSTRACT

Articles comprising fabric softening compositions and detergent compositions are useful in providing cleaning and softening benefits to laundry through the wash cycle.

### CROSS REFERENCE TO RELATED APPLICATION(S)

This application claims the benefit of U.S. Provisional Application No. 60/738,274, filed Nov. 18, 2005.

### FIELD OF INVENTION

The present invention relates to articles comprising fabric softening compositions and detergent compositions.

### BACKGROUND OF THE INVENTION

Conventional fabric softening compositions are added in the rinse cycle of the laundering process to soften fabrics or as dryer added softener sheets to a machine dryer. However, adding such compositions during the rinse cycle can be inconvenient for the consumer, unless the consumer has a laundry washing machine that has a built-in fabric softener dispensing unit, a removable agitator post-mounted fabric softener dispenser, or has a fabric softener dosing device such as the DOWNY® Ball. Otherwise, the consumer has to monitor the laundering process and then manually add the fabric softener to the load as soon as the rinse cycle begins.

Softening-through-the-wash compositions (hereinafter referred to as “STW compositions”) are able to soften fabrics, and provide other conditioning benefits to fabrics while being added to the fabrics in the laundering process during the washing stage, negating the need to add a separate fabric conditioning composition to the rinse stage and/or drying stage of the laundering process. The STW compositions can thus be added to the load of laundry at the beginning of the laundering process, which provides the consumer with an efficient and easy way to soften fabrics during the laundering process.

While the STW compositions and articles can be useful and effective, the consumer can still desire even further convenience of conducting the laundry process. So called “2 in 1” compositions (i.e., a fabric softener or conditioning agent is combined or contained in the detergent composition itself) have been attempted for years. Usually, these 2 in 1 compositions fall short of providing the consumer with the desired fabric softening or conditioning performance. Besides low softness and antistatic performance, various phase stability problems can occur with 2 in 1 compositions. Yet, there is a growing need and continuing consumer interest in 2 in 1 detergents, especially liquid detergents.

Thus the need still exists to provide an improved softening-through-the-wash product that provides effective deposition of a fabric softening active on the treated fabrics to provide the consumer a noticeable softening benefit yet still provide acceptable cleaning performance of a traditional laundry detergent.

### SUMMARY OF THE INVENTION

The present invention is directed, in a first aspect, to a an article comprising at least a first compartment releasably containing a first composition, and a second compartment releasably containing a second composition; wherein the first composition comprises a cationically charged fabric softening active, and is essentially free of a detersive surfactant; wherein the second composition comprises a detersive surfactant, and is essentially free of a cationically charged fabric softening active.

A second aspect of the invention is directed to a method of softening a fabric comprising the step of dosing an the article of Claim 1 to the wash cycle of an automatic laundry washing machine.

A third aspect of the invention is directed to a kit comprising: (a) an article of the present invention; and (b) optionally instructions instructing the user to dose the article to the wash cycle of an automatic washing machine.

### DETAILED DESCRIPTION OF THE INVENTION

One aspect of the invention provides for a laundry article comprising a fabric softening composition in first compartment and a laundry detergent composition in a second compartment. In one embodiment, the fabric softening composition is free or essentially free of a detersive surfactant. In another embodiment, the laundry detergent is free or essentially free of a fabric softening active. Alternatively, the laundry detergent is free or essentially free of a cationic fabric softening active.

Fabric Care Active

One aspect of the invention provides for a fabric softening composition comprising a fabric softening active. In one embodiment, the fabric softening active is from about 1% to about 90% by weight of the fabric softening composition. In yet another embodiment, the fabric softening active is cationically charged. In yet still another embodiment, the fabric softening active comprises a quaternary ammonium compound.

Diester Ouaternary Ammonium (DEQA) Compounds

In one embodiment, the fabric softening active comprises a DEQA compound. The DEQA compounds encompass a description of diamido fabrics softener actives as well as fabric softener actives with mixed amido and ester linkages.

A first type of DEQA suitable as a fabric softening active in the present compositions includes compounds of the formula:
{R₄₋ₘ—N⁺—[(CH₂)ₙ—Y—R¹]ₘ}X⁻
wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR—and it is acceptable for each Y to be the same or different; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate.

Other suitable fabric softening actives are described in U.S. Pat. Pub. 2004/0204337 A1, published Oct. 14, 2004, at paragraphs 74-79.

In another embodiment, the fabric softening active is chosen from at least one of the following: ditallowoyloxyethyl dimethyl ammonium chloride, dihydrogenated-tallowoyloxyethyl dimethyl ammonium chloride, dicanola-oyloxyethyl dimethyl ammonium chloride, ditallow dimethyl ammonium chloride, tritallow methyl ammonium chloride, methyl bis(tallow amidoethyl)2-hydroxyethyl ammonium methyl sulfate, methyl bis(hydrogenated tallow amidoethyl)-2-hydroxyethyl ammonim methyl sulfate, methyl bis (oleyl amidoethyl)-2-hydroxyethyl ammonium methyl sulfate, ditallowoyloxyethyl dimethyl ammonium methyl sulfate, dihydrogenated-tallowoyloxyethyl dimethyl ammonium chloride, dicanola-oyloxyethyl dimethyl ammonium chloride, N-tallowoyloxyethyl-N-tallowoylaminopropyl methyl amine, 1,2-bis(hardened tallowoyloxy)-3-trimethylammonium propane chloride, and mixtures thereof.

Cationic Starch

One aspect of the invention provides a fabric softening composition comprising a cationic starch as a fabric softening active. In one embodiment, the fabric care compositions of the present invention generally comprise cationic starch at a level of from about 0.1% to about 7%, alternatively from about 0.1% to about 5%, alternatively from about 0.3% to about 3%, and alternatively from about 0.5% to about 2.0%, by weight of the composition. Cationic starch as a fabric softening active is described in U.S. Pat. Pub. 2004/0204337 A1, published Oct. 14, 2004, to Corona et al., at paragraphs 16-32. Suitable cationic starches for use in the present compositions are commercially-available from Cerestar under the trade name C*BOND® and from National Starch and Chemical Company under the trade name CATO® 2A.

Silicone

In one embodiment, the fabric softening composition comprises a silicone. Suitable levels of silicone may comprise from about 0.1% to about 50%, alternatively from about 1% to about 40%, alternatively from about 2% to about 30%, alternatively from about 3% to about 20% by weight of the composition. In one embodiment, the silicone is emulsified, preferably as a high internal phase emulsion (HIPE). Non limiting examples of silicones include those described in U.S. Pat. Pub. No. 2002/0077265 A1, to Buzzacarini et al., published June 20, 2002 at paragraphs 51-57. Yet other non limiting examples includes those described in U.S. Provisional Pat Appl. No. 60/653,897 filed Mar. 11, 2005 (P&G Case 9910P) and subsequent U.S. provisional and non-provisional patent applications thereof.

One example of a silicone is a polydialkylsilicone, alternatively a polydimethyl silicone (polydimethyl siloxane or “PDMS”), or a derivative thereof. In another embodiment, the silicone is chosen from an aminofunctional silicone, alkyloxylated silicone, ethoxylated silicone, propoxylated silicone, ethoxylated/propoxylated silicone, quaternary silicone, or a mixture thereof.

Other Fabric Softening Composition

Examples of other softening compositions can be found in US 2004-0204337 A1; U.S. Pat. Nos. 5,877,145; 5,545,340; 5,545,350; 6,559,117; 6,492,322; 4,439,335; 4,399,045; 6,323,172; 6,335,315; 6,369,025; 6,686,331; 6,608,024; and US 2003-0139312 A1 (for low/nil water softener compositions which are well suited for unit dose pouching with PVOH film).

Fabric Care Benefit Agents

In addition to or in lieu of fabric softening actives herein described, other materials can be used for fabric care benefit agents in fabric softening compositions of the present invention. Non-limiting examples of these other agents include: clays, fatty oils, such as fatty acids, triglycerides, fatty alcohols, fatty esters, fatty amides, fatty amines; sucrose esters, dispersible polyethylenes, and polymer latexes. These compounds are known in the art and are further described in U.S. Provisional Pat. Appl. No. 60/653,897 filed Mar. 11, 2005 (P&G Case 9910P) and subsequent U.S. provisional and non-provisional patent applications thereof. Examples of fatty acids are described in U.S. Provisional Pat. Appl. No. 60/621,204, filed Nov. 22, 2004 (P&G Case 9812P) and subsequent U.S. provisional and non-provisional patent application thereof. Clays are described in U.S. Pat. Pub. No. 2004/0142841 A1, published Jul. 22, 2004, to de Buzzaccarini et al., from paragraphs 74-99.

In one embodiment, the fabric softening composition or laundry detergent composition of the present invention is free or essentially free of any one or more of the described fabric softening actives or other fabric care benefit agents.

In another embodiment, the fabric softening composition is free or essentially free of a detersive surfactant.

Laundry Detergent Composition

One aspect of the invention provides for a laundry detergent composition. The laundry detergent composition comprises a detersive surfactant. The term “detersive surfactant” means a surfactant of the type and amount that provides a desirable cleaning property to laundry, preferably when administered to a retail consumer laundry machine. To be a “detersive surfactant”, the concentration of surfactants in a composition (including a fabric softener composition), must be sufficient to provide noticeable fabric cleaning and/or stain removal. For example, a fabric softener composition could contain a low level of nonionic surfactant to, for example, to provide some physical stability, but not at a high enough level to provide fabric cleaning.

In one aspect, compositions comprising a detersive surfactant are essentially free of a cationically charged fabric softening active. For example, a composition comprising a detersive surfactant can contain a low level of a monoalkyl or di-alkyl quaternary softening compound and still be “essentially free” of a cationically charged fabric softener active as long as the detersive surfactant composition does not provide a noticeable softening benefit. In one embodiment, the laundry detergent composition comprises, by weight, from about 5% to about 90% of a detersive surfactant, alternatively from about 5% to about 70%, alternatively from about 5% to about 40% of the surfactant, by weight of the composition. The detersive surfactant may comprise anionic, nonionic, cationic, zwitterionic and/or amphoteric surfactants. In a more specific embodiment, the detergent composition comprises anionic, nonionic, cationic, zwitterionic and/or amphoteric surfactants, or mixtures thereof, with the anionic surfactant less than about 5%, preferably less than about 3%, alternatively less than about 2%, alternatively less than about 1%, alternatively about 0% by weight of the composition. In yet another embodiment, the detergent composition is essentially free or free of an anionic surfactant. In yet still another embodiment, the detergent composition comprises nonionic, cationic, amphoteric, and/or zwitterionic surfactants, or mixtures thereof.

It may be necessary to limit the concentration of anionic surfactant delivered to the wash such that the milliequivalents of fabric softening actives, that are cationically charged, generally exceed the milliequivalents of anionic surfactants in the wash bath. Otherwise, the anionic or negatively charged detergent surfactants may interact with all or part of the cationic or positively charged softening agents, and the cationic softening agent may thus be rendered ineffective or less effective.

Anionic Determination Test

The “Anionic Determination Test” is herein defined. The amount of “free” anionic content in the product containing the mixture of anionic, nonionic and cationic surfactants is determined by analyzing the aqueous phase behaviour of the surfactant mixture using a two-phase titration method. An aqueous sample solution of the product is prepared. In solution oppositely charged surfactants generally form an insoluble ion pair complex that can be detected as a fine suspension in the solution or solubilized by the anionic surfactant in excess. The “free” anionic equivalents (in meq/g) in excess are determined by titration using a suitable aliquot of the sample solution prepared of the product depending on its surfactant content (10 mL of a 1-2% solution) combined with 20 mL of a mixed-indicator acidified solution (containing 40 ppm of cationic dimidium bromide and 20 ppm of anionic disulfine blue dyes available from Sigma-Aldrich Co., and 0.3% of concentrated sulfuric acid) and an aliquot of 15 mL of chloroform. If the product contain alkylamines or amine oxide they may protonate under acidic conditions and combine with the anionic surfactant present and give bias in the estimation of free anionics surfactant. In this case the sample aliquot and indicator mixture is made alkaline (pH>12) by adding few drops of a 10% NaOH solution. The complex between the anionic surfactants and the cationic dye indicator is red and soluble in the chloroform bottom layer. If the color of this organic layer is not red, there is no free anionic surfactant in the product. Upon titration with a standardized solution of Hyamine 1622 (a quaternary ammonium salt known as benzethonium chloride, Sigma-Aldrich Co.) the red dye-surfactant complex is broken and replaced by a colorless anionic surfactant-Hyamine complex. The first color change from red to grey in the organic layer that persists after further agitation indicates the titration end point. If an excess Hyamine is added to the solution it complexes with the anionic disulfine dye, giving a blue color to the chloroform layer indicating that the actual gray end point was passed. In the end point the equivalents of Hyamine spent correspond to all “free” anionic surfactant available in the product. The results can be reported as milliequivalents (meq) of anionics per gram (g) of sample (meq/g).

Anionic Surfactants

One aspect of the invention provides for a laundry detergent composition comprising an anionic surfactant such that when used in combination with a separate fabric softening composition, the meq of anionic surfactant species is less than the meq of cationic softener species, alternatively the anionic meq are less than about 5%, less than about 10%, less than about 15%, and less than about 20% of the cationic softener meq. Another aspect of the invention provides for a laundry detergent composition free or essentially free of an anionic surfactant.

Anionic surfactants may comprise any of the anionic surfactant that can be used in a laundry detergent product. Examples of anionic surfactants include those described in: U.S. Pat. Pub. 2004/0142841 A1, at paragraphs 44-55; U.S. Pat. Nos. 2,220,099 and 2,477,383; 6,020,303 and 6,060,443; 6,008,181 and 6,020,303; WO 99/05243, WO 99/05242, WO 99/05244, WO 99/05082, WO 99/05084, WO 99/05241, WO 99/07656, WO 00/23549, and WO 00/23548.

Other Surfactants

The laundry detergent composition of the present invention may comprise surfactant. Examples of surfactants are herein described.

Nonionic Surfactants: In one embodiment, the laundry detergent composition may comprise a nonionic surfactant. Non-limiting examples of nonionic surfactants are described in U.S. Pat. Pub. 2004/0142841 A1, published Jul. 22, 2004, at paragraphs 44-59.

Cationic Surfactants: In one embodiment, the laundry detergent composition may comprise a cationic surfactant. Non-limiting examples of these cationic surfactants include those described in U.S. Pat. Nos. 6,136,769; 6,004,922; WO 98/35002; WO 98/35003; WO 98/35004; WO 98/35005; WO 98/35006; U.S. Pat. Nos. 4,228,042; 4,239,660; 4,260,529; 6,022,844; 6,221,825; WO 00/47708; and U.S. Pat. Pub. 2004/0142841 A1, at paragraphs 60-67.

Zwitterionic Surfactants: In one embodiment, the laundry detergent composition may comprise a zwitterionic surfactant. Non-limiting examples of zwitterionic surfactants are described in U.S. Pat. Pub. 2004/0142841 A1, at paragraphs 70-72; U.S. Pat. Nos. 5,104,646; 5,106,609; and 3,929,678.

Amphoteric Surfactants: In one embodiment, the laundry detergent composition may comprise an amphoteric surfactant. Non limiting examples of amphoteric surfactants are described in U.S. Pat. Pub. 2004/0142841 A1, at paragraphs 68-69; U.S. Pat. Nos. 5,104,646; 5,106,609; and 3,929,678.

In one embodiment, the laundry detergent composition is free or essentially from of any of one or more of the surfactants: anionic, nonionic, cationic, zwitterionic, and amphoteric.

Optional Ingredients

The fabric softening composition and/or the laundry detergent composition may comprise an optional ingredient. Some optional ingredients include, but are not limited to builders, surfactants, enzymes, bleach activators, bleach catalysts, bleach boosters, bleaches, stabilizers (such as propylene glycol, boric acid and/or borax), suds suppressors, soil suspending agents, soil release agents, other fabric care benefit agents, pH adjusting agents, chelating agents, smectite clays, solvents, hydrotropes and phase stabilizers, structuring agents, dye transfer inhibiting agents, alkalinity sources, antibacterial agents, colorants, perfumes, pro-perfumes, finishing aids, lime soap dispersants, odor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hueing dyes, hydrotropes, suds or foam suppressors, suds or foam boosters and mixtures thereof.

In one embodiment, the fabric care composition or laundry detergent composition is free or essentially free of any one or more the aforementioned optional ingredients.

In one embodiment, the laundry detergent composition is free or essentially free of a fabric softening active or a fabric care benefit agent.

In one embodiment the first composition and/or the second composition comprises a perfume microcapsule. Perfume microcapsules may include those described in the following references: US 2003-215417 A1;US 2003-216488 A1; US 2003-158344 A1; US 2003-165692 A1; US 2004-071742 A1; US 2004-071746 A1; US 2004-072719 A1; US 2004-072720 A1; EP 1393706 A1; US 2003-203829 A1; US 2003-195133 A1; US 2004-087477 A1; US 2004-0106536 A1; U.S. Pat. Nos. 6,645,479; 6,200,949; 4,882,220; 4,917,920; 4,514,461; U.S. RE 32,713; U.S. Pat. No. 4,234,627. For purposes of the present invention, “perfume nanocapsules” are within the scope of the term “perfume microcapsule.”

Static Control Agents

One aspect of the invention provides for a composition of present invention comprising a static control agent (or “SCA”). In one embodiment, the static control agent comprises ion-pair conditioning particles. These and other conditioning agent containing amine ion-pair complexes are described in U.S. Pat. Nos. 4,861,502, 5,073,274, 5,019,280, 4,857,213, and 4,913,828 to Debra S. Caswell, et. al., and U.S. Pat. No. 4,915,854, to Mao, et. al. Other effective static control agents are provided in U.S. Patent Application Publication No. 2005/0020476 A1 to Wahl, et. al., from paragraphs 15-74.

It is surprisingly found that perfumes can negatively interact with the distearyl amine/cumene sulfonic acid and distearyl amine/sulfuric acid prill, particularly under long term storage conditions. While not wishing to be bound by theory, it is believed that perfume components (perfume raw materials) that are hydrophobic solublize and/or destroy the ion pair prill leading to eventual breakup of the prill into smaller pieces and eventually chemical reversion of the acid/base reaction that formed the ion pair. This perfume interaction with the ion pair may be solved in several ways. When the fabric softener composition is used in combination with a detergent composition, for example, in a dual compartment container (e.g., in a dual pour article where the fabric softening composition and the detergent composition are dispensed at the same time but are physically separated in compartments in one container), then the perfume can be added to the laundry detergent composition; and the distearyl amine/cumene sulfonic acid and distearyl amine/sulfuric acid prill can be added to the fabric softening composition. Another potential solution to this problem is to formulate the SCA into the laundry detergent composition and the perfume into the fabric softening composition. Thus, under either approach, the perfume and SCA are physically separated in storage in the container and no undesirable interactions can occur between the perfume and the SCA.

This same approach can be used for unit dose packaging for the STW composition with either articles comprised of water-soluble or non-water soluble film or dual compartment articles such as containers or trays, or pouches, or sachets and the like.). The SCA and the perfume are physically separated since the SCA is in one compartment of the article and the perfume is in the other compartment of the article.

Thus, one aspect of the invention provides for a fabric softening composition comprising a SCA yet is free or essentially free of a perfume. Alternatively, the fabric softening composition comprises a perfume yet is free or essentially free of a SCA. Another aspect of the invention provides for a laundry detergent composition comprising a SCA yet is free or essentially free of a perfume. Alternatively, the laundry detergent composition comprises a perfume yet is free or essentially free of a SCA.

Article Forms

Preferred forms of the composition (i.e., fabric softening or laundry detergent) of the present invention are liquids and gels. The compositions can also be in the form of a paste, semi-solid, suspension, powder, or any mixture thereof. A dual compartment article, for example a dual compartment unit dose made from water soluble film can be comprised of the same or two different forms, for example a liquid/powder pouch, a liquid/liquid pouch, or a gel/powder pouch.

The compositions of the present invention can be dosed, as an article, to the wash cycle, preferably as a unit dose composition. It is preferred that the film of the coating material be water-soluble, preferably made of polyvinyl alcohol or a derivative of polyvinyl alcohol. Films comprised of hydroxypropyl methylcellulose and polyethylene oxide may also be used, as well as mixtures thereof, and mixtures with polyvinyl alcohol. Water-insoluble films can also be used, such as polyethylene and the like, for pouching.

Water-soluble films are available from a variety of commercial sources. For example, polyvinyl alcohol films are commercially available from a number of sources including MonoSol LLC of Gary, Ind., Nippon Synthetic Chemical Industry Co. Ltd. Of Osaka Japan, and Ranier Specialty Chemicals of Yakima, Wash. These films may be used in varying thicknesses ranging from about 20 to about 80 microns, alternatively from about 25 to about 76 microns. In one embodiment, the film comprises a thickness of about 25 to about 76 micrometers for rapid dissolution in a cold water wash. Where larger volumes of composition are to be contained in encapsulate, volumes exceeding about 25 ml, a thicker film may be desired to provide additional strength and integrity to the encapsulate. Further, it is preferred that the water-soluble films be printable and colored as desired.

Suitable methods of preparing unit dose articles include those described in the following references: U.S. Pat. No. 6,281,183 B1, EP1126070, WO0183668, WO0183669, WO0185898, WO0183661, WO0183657, WO0183667, WO0185892, WO00208380, WO0212432, WO0220361, WO0240351, WO00183658, WO0240370, WO0160966, WO002060758, WO02060980, WO02074893, WO02057402, WO03008513, WO03008486, WO03031266, WO03045812, WO03045813, WO02060757, EP1354939, EP1375351, EP1396440, EP1431383, EP1431384, EP1340692, WO004085586. A unit dose article can also consist of the enclosed composition of the present invention shaped into a spherical bead as is described in WO 97/35537.

If the packaging is a dual compartment, dual pouring plastic bottle, for example, it may be necessary to control the flow of liquid product from each compartment so that the correct dosage of each product is obtained in the washing cycle. The amount of each liquid dispensed per time period (for example, per second) can be controlled by several different methods. For example, the rheology of each liquid composition can be matched to provide similar flow characteristics. Or the dual compartment bottle can be designed in such a way that one compartment dispenses product at the same rate or a faster rate than the other compartment. One way to slow the flow of a liquid in one compartment compared to another liquid in another compartment is to have a smaller diameter opening in the pouring spout. Flow restrictors can be used in the pouring spout as well.

Any container comprising at least two compartments may be suitable. Non-limiting examples of such a container are described in include: U.S. Pat. No. 4,765,514; U.S. Pat. Appl. Pub. 2002/0077265 A1; U.S. Pat. Appl Pub. 2002/0074347 A1.

The term “essentially free” is used throughout the specification. In one embodiment, the term means that there is from about 0.0001% to about 5%, from about 0.001% to about 3%, alternatively from about 0.01% to about 1%, by weight of the composition of the ingredient in question.

Methods

One aspect of the present invention provides a method of using the composition of the present invention to wash and softening laundry by dosing an article of the present invention in the wash cycle of an automatic laundry washing machine. Another aspect of the invention provides for a kit comprising the article and optionally instructions for use.

### EXAMPLES

Fabric softening compositions are described in Examples I-XV.

| | Examples | | | | |
|---|---|---|---|---|---|
| INGREDIENTS | I | II | III | IV | V |
| Fabric softening | 14.00% | 14.00% | 14.00% | 18.51% | 4.67% |
| active ^{a} | | | | | |
| Fabric softening | — | — | — | — | — |
| active ^{b} | | | | | |
| Fabric Softening | — | — | — | — | — |
| active ^{c} | | | | | |
| Ethanol | 2.28% | 2.28% | 2.28% | 2.91% | 0.76% |
| Isopropyl alcohol | — | — | — | — | — |
| Cationic starch ^{d} | — | 2.00% | 3.00% | 1.68% | 0.67% |
| Perfume | 1.58% | 1.58% | 1.58% | 1.28% | 0.50% |
| TMPD ^{e} | — | — | — | — | — |
| NEODOL ® 91-8 | — | — | — | — | — |
| PLURONIC ® L35 | — | — | — | — | — |
| Phase stabilizing | 0.25% | 0.25% | 0.25% | 0.25% | — |
| polymer ^{f} | | | | | |
| Calcium chloride | 0.250% | 0.300% | 0.350% | 0.545% | — |
| Magnesium | — | — | — | — | — |
| chloride | | | | | |
| DTPA ^{g} | 0.005% | 0.005% | 0.005% | 0.005% | 0.003% |
| Preservative ^{h} | 7.5 ppm | 7.5 ppm | 7.5 ppm | 7.5 ppm | 7.5 ppm |
| Antifoam ⁱ | 0.011% | 0.011% | 0.011% | 0.011% | 0.011% |
| Liquitint Blue | — | 30 ppm | 60 ppm | 20 ppm | — |
| DW ^{j} | | | | | |
| Ammonium | 0.1% | 0.1% | 0.1% | 0.1% | — |
| chloride | | | | | |
| Hydrochloric acid | 0.012% | 0.012% | 0.012% | 0.0125% | 0.0004% |
| Deionized water | Balance | Balance | Balance | Balance | Balance |

^{a} N,N-di(tallowoyloxyethyl)-N,N-dimethylammonium chloride.
^{b} N,N-di(canola-oyloxyethyl)-N,N-dimethylammonium chloride.
^{c} Methyl bis(tallow amidoethyl)2-hydroxyethyl ammonium methyl sulfate.
^{d} Cationic starch based on common maize starch or potato starch, containing 25% to 95% amylose and a degree of substitution of from 0.02 to 0.09, and having a viscosity measured as Water Fluidity having a value from 50 to 84.
^{e} 2,2,4-trimethyl-1,3-pentanediol.
^{f} Copolymer of ethylene oxide and terephthalate having the formula described in U.S. Pat. No. 5,574,179 at col. 15, lines 1-5, wherein each X is methyl, each n is 40, u is 4, each R¹ is essentially 1,4-phenylene moieties, each R² is essentially ethylene, 1,2-propylene moieties, or mixtures thereof.
^{g} Diethylenetriaminepentaacetic acid.
^{h} KATHON ® CG available from Rohm and Haas Co.
ⁱ Silicone antifoam agent available from Dow Corning Corp. under the trade name DC2310.
^{j} Available from Milliken Chemical Company (nominally 100%)

| | Examples | | | |
|---|---|---|---|---|
| INGREDIENTS | VI | VII | VIII | IX |
| Fabric softening | — | — | 2.50% | 2.00% |
| active ^{a} | | | | |
| Fabric softening | 18.00% | 15.00% | — | — |
| active ^{b} | | | | |
| Fabric Softening | 3.00% | — | — | — |
| active ^{c} | | | | |
| Ethanol | 2.45% | 2.04% | 0.41% | 0.33% |
| Isopropyl alcohol | 0.33% | — | — | — |
| Cationic starch ^{d} | 1.68% | 2.00% | 0.35% | 0.70% |
| Perfume | 1.30% | 2.00% | 0.03% | 0.03% |
| TMPD ^{e} | 5.00% | 4.50% | — | — |
| NEODOL ® 91-8 | 2.15% | 2.75% | — | — |
| PLURONIC ® L35 | 1.50% | 1.27% | — | — |
| Phase stabilizing | — | — | — | — |
| polymer ^{f} | | | | |
| Calcium chloride | — | — | — | — |
| Magnesium | 2.00% | 2.00% | — | — |
| chloride | | | | |
| DTPA ^{g} | 0.20% | 0.02% | — | — |
| Preservative ^{h} | — | — | 7.5 ppm | 7.5 ppm |
| Antifoam ⁱ | — | — | — | — |
| Liquitint Blue | 60 ppm | — | 10 ppm | — |
| DW ^{j} | | | | |
| Ammonium | — | — | — | — |
| chloride | | | | |
| Hydrochloric acid | 0.016% | 0.016% | 0.002% | 0.002% |
| Deionized water | Balance | Balance | Balance | Balance |

| INGREDIENTS | Example X | Example XI | Example XII |
|---|---|---|---|
| Softener active (85%) ^{k} | 75.08% | 77.087% | 87.565% |
| TMPD ^{e} | 14.73% | — | — |
| Canola fatty acid | 1.84% | — | — |
| 1,4-CHDM ^{l} | — | 7.174% | — |
| Neodol 91-8 ^{m} | — | 6.696% | 7.606% |
| Cocoamide 6EO ⁿ | 4.05% | — | — |
| Hexylene glycol | — | 4.783% | — |
| Perfume | 4.30% | 4.185% | 4.754% |
| Acid blue 80 dye | 0.00075% | 0.00075% | 0.00075% |

^{k} Di(acyloxyethyl)(2-hydroxy ethyl) methyl ammonium methyl sulfate wherein the acyl group is derived from partially hydrogenated canola fatty acid. Active contains about 7.5% hexylene glycol and 7.5% of ethanol solvent which is about 95% ethanol and about 5% water.
^{l} 1,4-cyclohexanedimethanol.
^{m} alkyl C9-C10 ethoxylated alcohol with an average of 8 moles EO (from Shell).
ⁿ PEG 6 cocamide - polyethylene glycol amide of coconut fatty acid.

| | Example | Example | Example |
|---|---|---|---|
| INGREDIENTS | XIII | XIV | XV |
| DTDMAC ^{o} | 8.30% | 5.8% | — |
| Varisoft-222 ^{p} | 12.60% | — | — |
| Varisoft WE-16 ^{q} | — | — | 6.75% |
| Isopropyl alcohol | 6.97% | 1.93% | 0.75% |
| Perfume | 1.00% | 0.30% | 0.90% |
| Calcium chloride | 0.45% | 0.01% | 0.02% |
| Glutaraldehyde | 0.025% | 0.025% | 0.025% |
| Antifoam ⁱ | 0.011% | 0.011% | 0.011% |
| Acid blue 80 Dye | 40 ppm | 30 ppm | 60 ppm |
| Deionized water | Balance | Balance | Balance |

^{o} di-hard tallow dimethyl ammonium chloride (from Degussa)
^{p} methyl bis (tallowamidoethyl) 2-hydroyethyl ammonium methyl sulfate (from Degussa)
^{q} di-(tallowoyloxyethyl)-N,N-methylhydroxyethylammonium methyl sulfate (from Degussa)

Detergent compositions are described in Examples XVI-XXII.

| | XVI | XVII | XVIII | XIX | XX | XXI⁴ | XXII⁴ |
|---|---|---|---|---|---|---|---|
| INGREDIENTS | Wt % | Wt % | Wt % | Wt % | Wt % | Wt % | Wt % |
| Linear | | | | 2.0 | 2.0 | | 5.0 |
| alkylbenzene | | | | | | | |
| sulfonic acid | | | | | | | |
| Sodium alkyl ether | | | 2.0 | | 2.0 | | |
| sulfate | | | | | | | |
| Alkyl ethoxylates | 11.6 | 15.5 | 15.0 | 10.0 | 17.0 | 58.2 | 50.8 |
| Alkylamidopropyl | | | | | | 1.7 | 3.3 |
| amine | | | | | | | |
| Alkyldimethyl | 3.4 | 4.5 | 3.0 | | | | |
| amine oxide | | | | | | | |
| Citric acid | 3.4 | 4.0 | 4.0 | | 1.9 | 1.5 | 3.2 |
| DTPMP ¹ | 0.25 | | | | | 0.9 | |
| HEDP ² | 0.3 | | | | | | |
| DTPA ³ | | 0.1 | 0.1 | 0.3 | | | 0.3 |
| Amine ethoxylate | 2.0 | 1.8 | 1.8 | 1.0 | | 3.0 | 3.7 |
| polymers | | | | | | | |
| Ethanol | 0.4 | 1.5 | 1.5 | 1.0 | 1.5 | | |
| 1,2-propanediol | 6.3 | 4.5 | 4.5 | 2.5 | 2.0 | 22.7 | 17.5 |
| Sorbitol | | | | | 4.0 | | |
| Monoethanolamine | to pH | | | 0.5 | 0.1 | to pH | to pH |
| | 8.0 | | | | | 8.0 | 8.0 |
| Sodium hydroxide | | to pH | to pH | to pH | to pH | | |
| | | 8.0 | 8.0 | 8.0 | 8.5 | | |
| Protease | 0.5 | 1.0 | 1.0 | 0.5 | 1.0 | 1.0 | 1.8 |
| Amylase | 0.1 | 0.2 | 0.2 | | | 0.5 | 0.4 |
| Lipase | | | | | 0.1 | | 0.1 |
| Formic acid | | | | | | 1.0 | 1.0 |
| Calcium chloride | 0.03 | | | | | 0.1 | |
| Calcium and | | 0.2 | 0.2 | 1.5 | | | 0.5 |
| sodium formate | | | | | | | |
| Boric acid | 2.0 | | | | | | |
| Borax | | 1.5 | 1.5 | 1.0 | 2.9 | | |
| Fluorescent | 0.09 | 0.15 | 0.15 | 0.05 | 0.12 | 0.25 | 0.25 |
| whitening agent | | | | | | | |
| Perfume | 0.2 | | | | | 0.5 | |
| Dye | 0.001 | 0.001 | 0.001 | 0.001 | 0.001 | 0.002 | 0.002 |
| Water | Balance | Balance | Balance | Balance | Balance | Balance | Balance |
| Dose (grams per | 117 | 99 | 99 | 99 | 98 | 50 | 50 |
| load) | | | | | | | |
| Free anionic | 0 | 0 | 0.05 | 0.06 | 0.12 | 0 | 0.31 |
| surfactant (meq per | | | | | | | |
| gram) | | | | | | | |

¹ diethylenetriaminepentakismethylenephosphonic acid, sodium salt
² hydroxyethyl-1,1-diphosphonic acid
³ diethylenetriaminepentaacetic acid, sodium salt
⁴compact formula, packaged as a unitized dose in polyvinyl alcohol film

Examples of Articles are described in Examples XXIII-XXIV.

### XXIII

An article of manufacture is made by placing the softener composition of Example II in one compartment of a dual compartment, dual pour polyethylene bottle. In the other compartment is placed the detergent composition of Example XVII.

### XXIV

An article of manufacture is made by placing the softener composition of Example XIII in one compartment of a dual compartment, dual pour polyethylene bottle. In the other compartment is placed the detergent composition of Example XVII.

### XXV

An article of manufacture is made by placing the softener composition of Example XIII in one compartment of a dual compartment, dual pour polyethylene bottle. In the other compartment is placed the detergent composition of Example XX.

### XXVI

An article of manufacture is made by placing the softener composition of Example I in one compartment a dual compartment tray. In the other compartment is placed liquid detergent composition of Example XIX. The softener compartment holds about 30 g and the detergent compartment holds about 99 g. The tray has a non-water soluble peel-off lid.

### XXVII

Another article of manufacture is made by placing the fabric softening composition of Example IV in one compartment a dual compartment plastic pouch (non-water soluble). In the other compartment is placed a detergent composition of Example XVIII. The softener compartment holds about 30 g and the detergent compartment holds about 99 g.

### XXVIII

An article of manufacture is made by placing the softener composition of Example XI in one compartment of a dual compartment, water soluble PVOH pouch. In the other compartment is placed a liquid detergent formula of Example XXI. The softener compartment holds about 10 g and the detergent compartment holds about 50 g. PVOH film is M-8630, 3 mil thickness, and supplied by MonoSol LLC.

### XXIV

An article of manufacture is made by placing the softener composition of Example XII in one compartment of a dual compartment, water soluble PVOH pouch. In the other compartment is placed a liquid detergent formula of Example XXII. The softener compartment holds about 10 g and the detergent compartment holds about 50 g. PVOH film is M-8630, 3 mil thickness, and supplied by MonoSol LLC.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article comprising at least a first compartment releasably containing a first composition, and a second compartment releasably containing a second composition;
wherein the first composition comprises a cationically charged fabric softening active, and is essentially free of a detersive surfactant;
wherein the second composition comprises a detersive surfactant, and is essentially free of a cationically charged fabric softening active.

2. The article of claim 1 wherein the second composition comprises less than about 0.3 meq of free anionic surfactant per gram of the second composition as determined by the Anionic Determination Test.

3. The article of claim 2 wherein the laundry detergent composition contains less than about 0.1 meq of free anionic surfactant per gram of the detergent composition.

4. The article of claim 3 wherein the laundry detergent composition contains about zero meq of free anionic surfactant per gram of the detergent composition.

5. The article of claim 1, wherein the first composition comprises a static control agent yet is essentially free of a perfume; and wherein the second composition is essentially free of an antistatic control agent and comprises a perfume.

6. The article of claim 1, wherein the first composition comprises a perfume yet is essentially free of a static control agent; and wherein the second composition comprises an antistatic control agent yet is essentially free of a perfume.

7. The article of claim 5, wherein the static control agent is ion-pair conditioning particles.

8. The article of claim 6, wherein the static control agent is ion-pair conditioning particles.

9. The article of claim 7, wherein the ion-pair conditioning particle comprises a distearyl amine/cumene sulfonic acid and distearyl amine/sulfuric acid prill.

10. The article of claim 8, wherein the ion-pair conditioning particle comprises a distearyl amine/cumene sulfonic acid and distearyl amine/sulfuric acid prill.

11. The article of claim 9, wherein the article is water soluble.

12. The article of claim 9, wherein the article is water insoluble.

13. The article of claim 10, wherein the article is water soluble.

14. The article of claim 10, wherein the article is water insoluble.

15. The article of claim 1, wherein the article is water insoluble; and wherein either the first composition or the second composition further comprises a perfume microcapsule.

16. The article of claim 15, wherein the article comprises a dual compartment plastic bottle, wherein the bottle comprises a means to dose the first composition and the second composition concurrently.

17. The article of claim 1, wherein the article comprises a unit dose and comprises a water soluble film.

18. The article of claim 1, wherein the second composition comprises an amount of an anionic surfactant, if present, such that when the article is dosed in a laundry bath comprising only water results in a milliequivalent (“meq”) of the cationically charged fabric softening active exceeding that of a meq of the anionic surfactant as determined by the Anionic Determination Test.

19. A method of softening a fabric comprising the step of dosing an the article of claim 1 to the wash cycle of an automatic laundry washing machine.

20. A kit comprising: (a) an article of the present invention; and (b) instructions instructing the user to dose the article to the wash cycle of an automatic washing machine.
